(19) United States
(12) Patent Application Publication
(10) Pub. No.: US 2023/0291223 A1
(43) Pub. Date: Sep. 14, 2023

(54) Hand-Held Power Tool with a Work Field Lighting

(71) Applicant: Robert Bosch GmbH, Stuttgart (DE)

(72) Inventors: Khoo Ming Yang Calvin, Penang (MY); Chee Hao Ong, Penang (MY)

(21) Appl. No.: 18/111,762

(22) Filed: Feb. 20, 2023

(30) Foreign Application Priority Data
Mar. 10, 2022 (DE) 10 2022 202 409.5

(51) Int. Cl. B25B 23/18; B25F 5/00

(52) U.S. Cl. CPC B25B 23/18; B25F 5/00

(57) ABSTRACT

In a hand-held power tool, in particular a screwdriver, having a work field lighting and an elongated housing, in which a drive unit is arranged, comprising at least one drive motor for driving a toolholder, wherein the toolholder is configured so as to accommodate an application tool, and with a battery for network-independent power supply, wherein, in a charging operation for a charging, the battery is electrically conductively connectable to an external charging apparatus, a control electronics is associated with the work field lighting and is configured so as to visualize a charging of the battery in the charging operation by a repeated illumination and dimming of the work field lighting.

This application claims priority under 35 U.S.C. § 119 to patent application no. DE 10 2022 202 409.5, filed on Mar. 10, 2022 in Germany, the disclosure of which is incorporated herein by reference in its entirety.

The present disclosure relates to a hand-held power tool, in particular a screwdriver, having a work field lighting and an elongated housing, in which a drive unit is arranged, comprising at least one drive motor for driving a toolholder, wherein the toolholder is configured so as to accommodate an application tool, and with a battery for network-independent power supply, wherein, in a charging operation for a charging, the battery is electrically conductively connectable to an external charging apparatus.

### BACKGROUND

From the prior art, a rod screwdriver is known. The rod screwdriver comprises a drive motor in the housing for driving an associated toolholder. Furthermore, the rod screwdriver comprises a work field lighting for illuminating a work field to be machined. In addition, the rod screwdriver comprises a battery for the network-independent power supply. LEDs are arranged on the housing of the rod screwdriver which visualizes a respective battery charge level during a charging operation of the battery.

### SUMMARY

The disclosure relates to a hand-held power tool, in particular a screwdriver, having a work field lighting and an elongated housing, in which a drive unit is arranged, comprising at least one drive motor for driving a toolholder, wherein the toolholder is configured so as to accommodate an application tool, and with a battery for network-independent power supply, wherein, in a charging operation for a charging, the battery is electrically conductively connectable to an external charging apparatus. Control electronics are associated with the work field lighting and are configured so as to visualize a charging of the battery by a repeated illumination and dimming of the work field lighting during the charging operation.

The disclosure thus enables the provision of a hand-held power tool, in which simple and straightforward control of work field lighting for visualizing a charging operation of the battery can be enabled by the control electronics.

Preferably, the control electronics comprise a detection unit for detecting an external charging apparatus electrically conductively connected to the battery and configured so as to initiate a charging operation of the battery in response to a detection of the external charging apparatus.

Thus, upon detection of an electrical connection of the hand-held power tool to the external charging apparatus, a charging operation can be started in an automated manner.

Preferably, the control electronics comprise a charging control unit configured so as to initiate the charging operation and terminate it after successful charging.

Thus, a charging operation can be safely and reliably terminated.

According to one embodiment, the control electronics are associated with a battery charge level sensing unit configured so as to sense a respective current battery charge level.

Thus, a charging operation can be controlled and terminated easily and straightforwardly. Alternatively, the determined battery charge level can be visually illustrated to a user.

The control electronics are preferably associated with a brightness control for controlling a respective brightness of the work field lighting, wherein the brightness control comprises at least one transistor and/or one MOSFET.

Thus, a desired brightness of the work field lighting can be easily adjusted during a charging operation.

Preferably, the control electronics are configured so as to deactivate the work field lighting after the battery has been fully charged.

Thus, a complete charging of the battery can be easily and straightforwardly visualized.

According to one embodiment, the control electronics are associated with a switch element, wherein, upon activation of the switch element, a battery charge level is visualized in the operation of the hand-held power tool.

Thus, a battery charge level can be easily visualized in the operation of the hand-held power tool.

The switch element is preferably configured in the manner of a switch that is activatable by a user of the hand-held power tool.

Thus, easy and straightforward activation of a visualization of the battery charge level in the operation of the hand-held power tool by a user of the hand-held power tool can be enabled.

According to one embodiment, an activation unit for activating the drive motor is provided, wherein an activation of the drive motor takes place by a biasing of an application tool arranged in the toolholder against a workpiece to be machined, in particular along a longitudinal axis of the hand-held power tool.

Thus, an activation of the drive motor can be facilitated in a simple manner.

Moreover, the present disclosure relates to a method for charging a battery of a hand-held power tool, in particular a screwdriver, having a work field lighting and an elongated housing, in which a drive unit is arranged, comprising at least one drive motor for driving a toolholder, and a battery for network-independent power supply, wherein, in a charging operation for a charging, the battery is electrically conductively connectable to an external charging apparatus, wherein the method comprises the following steps:
electrically conductively connecting the charging apparatus to the battery,
detecting, by a detection unit, the electrically conductive connection of the battery to the charging apparatus,
activating a charging operation by a charging control unit, and
activating the work field lighting, wherein a repeated illumination and dimming of the work field lighting occurs during the charging operation.

The disclosure thus enables the provision of a method for charging a battery of a hand-held power tool, in which a simple and straightforward control of work field lighting for visualizing a charging operation of the battery can be enabled by the control electronics.

Preferably, prior to an activation of the charging control unit, a detection of a battery charge level is performed by a battery charge level sensing unit.

Thus, a charging of the battery can be facilitated in a straightforward manner depending on a detected battery charge level.

### BRIEF DESCRIPTION OF THE DRAWINGS

The disclosure is explained in further detail in the following description with reference to exemplary embodiments shown in the drawings. The figures show:

FIG. 1 a side view of a hand-held power tool according to the present disclosure having a work field lighting and a charging apparatus,

FIG. 2 a longitudinal section through a drive unit associated with the hand-held power tool of FIG. 1 in the activated state,

FIG. 3 an enlarged view of the longitudinal section by the drive unit of FIG. 2 in the deactivated state,

FIG. 4 a schematic view of an arrangement of control electronics associated with the hand-held power tool of FIG. 1 to FIG. 3 for controlling the work field lighting, as well as the work field lighting,

FIG. 5 a schematic view of a block diagram of the control electronics of FIG. 4,

FIG. 6 a sub-region of an exemplary flow diagram of a charging operation of the hand-held power tool of FIG. 1 to FIG. 3 with the control electronics of FIG. 4 and FIG. 5,

FIG. 7 a further sub-region of the exemplary flowchart of FIG. 6, and

FIG. 8 a further sub-region of the exemplary flowchart of FIG. 6 and FIG. 7.

### DETAILED DESCRIPTION

Elements having the same or a comparable function are provided with the same reference numerals in the figures and are described in detail only once.

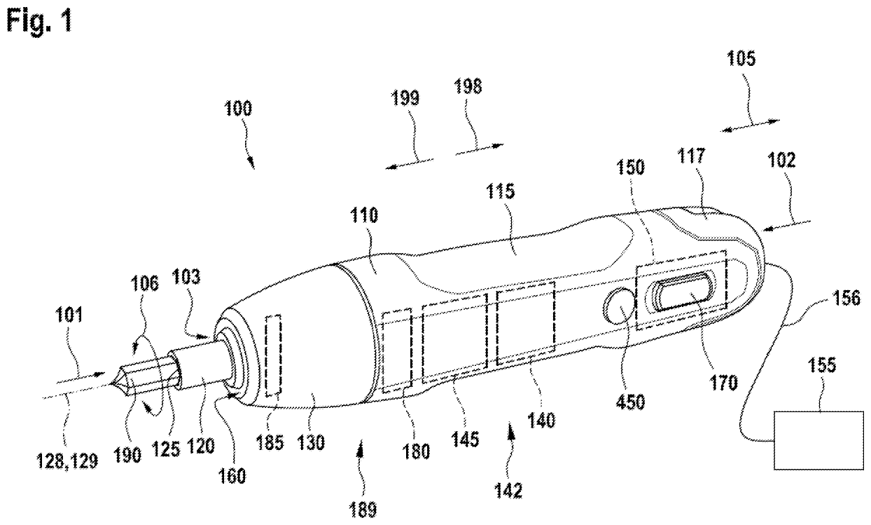

FIG. 1 illustrates an exemplary hand-held power tool 100 illustrated to have an elongated housing 110. The term “elongated housing” is understood in the present description to mean a housing whose longitudinal extension is many times greater than the transverse extension thereof. Thus, with the elongated housing 110, the hand-held power tool 100 is configured by way of example in the so-called “rod shape.”

Preferably, the hand-held power tool 100 is configured as a screwdriver, in particular as a rod screwdriver. According to one embodiment, the hand-held power tool 100 is mechanically and electrically connected to a drive unit 150 for network-independent power supply. Preferably, the power supply unit 150 is configured as a battery. It is noted that the battery 150 is preferably secured in the elongated housing 110 such that, preferably, the battery 150 remains in the elongated housing 110 during a charging operation of the battery 150.

Furthermore, a drive unit 142 for driving the toolholder 120 is arranged in the elongated housing 110. Preferably, the drive unit 142 comprises at least one drive motor 140 for driving the toolholder 120. The toolholder 120 is preferably associated with an internal receptacle 125 for accommodating an application tool 190, e.g., a screwdriver bit or drill. According to one embodiment, the drive unit 142 is further associated with a transmission 145. Preferably, the transmission 145 is configured as a planetary gear train. However, the hand-held power tool 100 can also be configured without a transmission 145.

The elongated housing 110 preferably comprises a cylindrical base body having a first axial end 101 and an opposite second axial end 102, wherein the toolholder 120 is arranged in the region of the first axial end 101, for example. In the illustration, a longitudinal direction 105 of the elongated housing 110 is formed between the first and second axial ends 101, 102. The toolholder 120 is preferably associated with an axis of rotation 129. Furthermore, the elongated housing 110 is illustrated to have a circumferential direction 106.

In the hand-held power tool 100 shown in FIG. 1, the toolholder 120, the drive motor 140, and the elongated housing 110 are arranged with a grip region 115 and a lid 117 coaxially to a common axis of arrangement, preferably corresponding to the axis of rotation 129 of the toolholder 120 and the longitudinal axis of the elongated housing 110, respectively. Thus, compared to a hand-held power tool having a gun-shaped housing in which the battery is arranged perpendicular to the axis of rotation of the toolholder 120, which is well known from the prior art, the battery 150 in the hand-held power tool 100 is also preferably arranged along the axis of rotation 129 of the toolholder 120, as described above. Preferably, all elements of the hand-held power tool 100 are arranged in the elongated housing 110.

Furthermore, a sliding switch 170 is preferably provided, which is arranged on the elongated housing 110 in order to activate a reversing operation of the drive motor 140. Likewise, the elongated housing 110 preferably has a torque adjustment sleeve 130 at its axial end 101. Moreover, the lid 117 is preferably arranged on the axial end 102 of the elongated housing 110 facing away from the toolholder 120.

According to one embodiment, an activation unit 189 is provided for activating the drive motor 140 through a biasing of the toolholder 120 or of the application tool 190 arranged or accommodated in the toolholder 120 against a workpiece to be machined. A corresponding axial biasing of the toolholder 120 or the application tool 190, i.e., an axial direction application, is preferably carried out in the longitudinal direction 105 against the workpiece to be machined. Preferably, an in particular axial biasing of the toolholder 120 of at least 0.1 Nm activates the drive motor 140. Generally, in the present description, the term “axially” or “in the axial direction” refers to a direction in the longitudinal direction 105 of the elongated housing 110, in particular a direction coaxial or parallel to the axis of rotation 129 of the toolholder 120.

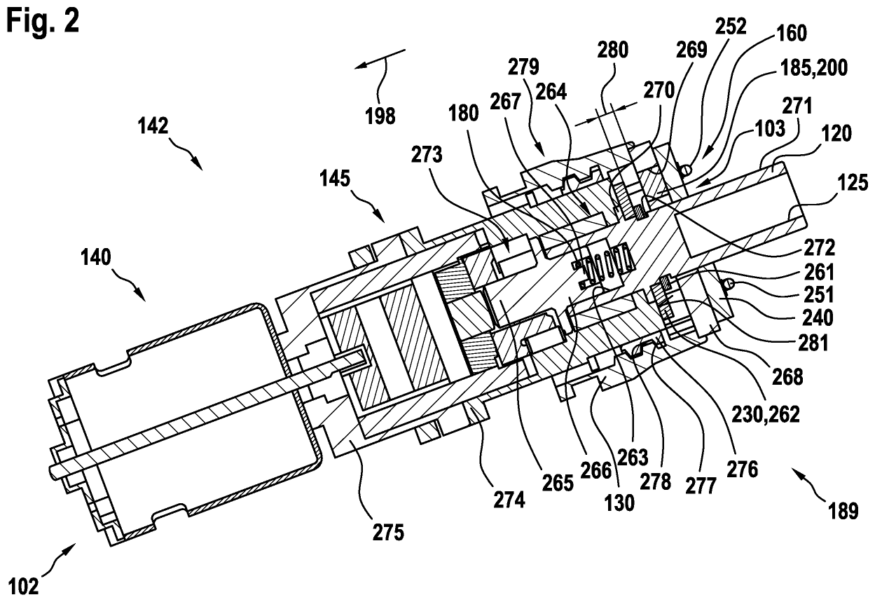

The activation unit 189 is preferably arranged along a longitudinal axis 128 between the drive motor 140 and the first axial end 101 of the elongated housing 110 and a front face 103 of the elongated housing 110, respectively. In the illustration, the longitudinal axis 128 corresponds to the axis of rotation 129. Here, activation of the drive motor 140 preferably occurs by a sliding of the toolholder 120 along the longitudinal axis 128 of the hand-held power tool 100. For this purpose, the activation unit 189 comprises a motor switch 185 arranged in the region of the toolholder 120. Preferably, the motor switch 185 configured as a motor off-switch (200 in FIG. 2) is arranged at or in the region of the front face 103 of the elongated housing 110. Furthermore, the toolholder 120 is preferably associated with an actuating element (230 in FIG. 2) for actuating the motor switch 185.

The motor switch 185 or motor off-switch (200 in FIG. 2), respectively, is preferably associated with the activation unit 189. Preferably, the actuating element (230 in FIG. 2) is biased against the motor off-switch 200 by a spring element 180 in a direction 199 that is indicative of the drive motor 140, thereby deactivating the drive motor 140.

Preferably, the spring element 180 is compressible by a biasing of the toolholder 120 towards the drive motor 140, i.e., in a direction 198 indicative of the drive motor 140. In so doing, the actuating element (230 in FIG. 2) releases the motor off-switch (200 in FIG. 2) and thus activates the drive motor 140. When the toolholder 120, or the application tool 190 arranged in the toolholder 120, is biased against the workpiece to be machined, the actuating element (230 in FIG. 2) is preferably spaced apart from the motor off-switch (200 in FIG. 2) and the drive motor 140 is activated.

It is noted that the motor switch 185 can also be configured as a motor on-switch. It is further noted that the motor switch 185 can also be arranged at any other desired location of the hand-held power tool 100 or in the elongated housing 110. Furthermore, according to an alternative embodiment, the activation unit 189 can also include only one control element for manually activating the drive unit 142 by a user of the hand-held power tool 100.

Moreover, a work field lighting 160 for lighting a work field or a workpiece to be machined is arranged on the front face 103 of the elongated housing 110. The work field lighting 160 illuminates the workpiece to be machined during a working operation, wherein an activation of the work field lighting 160 preferably occurs by an activation of the drive unit 142 or in response to such an activation. Here, the work field lighting 160 is permanently illuminated. Preferably, a deactivation of the work field lighting 160 occurs by a deactivation of the drive unit 142 or in response to such a deactivation.

Furthermore, an external charging apparatus 155 for charging the battery 150 is shown in FIG. 1. As shown in the illustration, to charge the battery 150, the external charging apparatus 155 is electrically conductively connected to the hand-held power tool 100 via a charging cable 156.

It is noted that the external charging apparatus 155 is only electrically conductively connected to the battery 150 of the hand-held power tool 100 for a charging operation. In the operation of the hand-held power tool 100, the external charging apparatus 155 is preferably not electrically conductively connected to the battery 150 of the hand-held power tool 100.

Furthermore, it is noted that the battery 150 can also be configured as a replaceable or exchangeable battery pack that can be releasably arranged on the hand-held power tool 100. In this case, however, during a charging operation, the battery 150 configured as a replaceable battery pack is arranged on the hand-held power tool 100. Furthermore, the electrically conductive connection of the external charging apparatus 155 can also be established via a wireless connection, e.g., an inductive coupling.

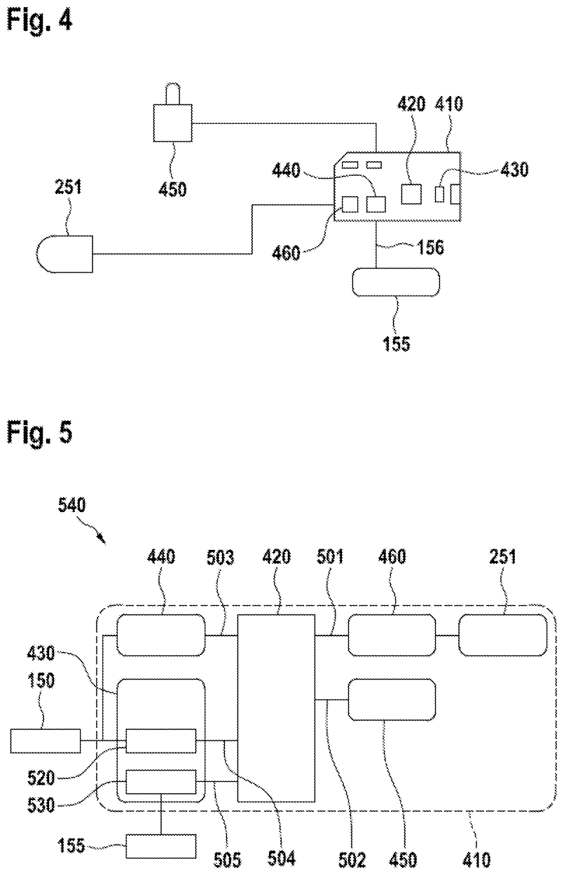

According to the present disclosure, the hand-held power tool 100 comprises control electronics (410 in FIG. 4) associated with the work field lighting 160 and configured so as to visualize a charging of the battery 150 during a charging operation by a repeated illumination and dimming of the work field lighting 160. Preferably, the control electronics (410 in FIG. 4) are arranged in the region of a side of the drive motor 140 facing the second axial end 102 of the elongated housing 110. According to one embodiment, the control electronics (410 in FIG. 4) are associated with an optional switch element 450, wherein, upon activation of the switch element 450, a charging operation is activatable.

FIG. 2 illustrates an exemplary drive unit 142 of the hand-held power tool 100 of FIG. 1. In this respect, FIG. 2 shows the optional transmission 145 arranged in a transmission housing 274, 275, as can be seen in the illustration. Preferably, the gearbox housing 274, 275 comprises a housing portion 274 arranged facing the toolholder 120 and a housing portion 275 facing the drive motor 140. Preferably, a front face 281 of the gearbox housing 274, 275, in particular the housing portion 274, facing the toolholder 120 serves as an axial abutment surface of the actuating element 230 when the drive motor 140 is deactivated.

Furthermore, a torque coupling is preferably provided, having a torque adjustment apparatus 279. The torque adjustment apparatus 279 comprises the torque adjustment sleeve 130 for adjusting a predetermined torque and a spring retainer ring 276. The torque adjustment sleeve 130 is preferably directly connected to the spring retainer ring 276 via a keying 277, 278. Here, the torque adjustment sleeve 130 preferably has an internal threading 278 on its inner circumference, and the spring retainer ring 276 has an external threading 277 on its outer circumference for forming the keying 277, 278.

In FIG. 2, the drive mover 140 is activated by way of example. A distance 280 is preferably formed between the actuating element 230, or an actuating portion 262, and the motor switch 185, or a motor off-switch 200, respectively. The distance 280 is created by the biasing of the toolholder 120, thereby compressing the spring element 180. The toolholder 120 preferably abuts a support element 270 on the front face 281 of the housing part 274.

To activate the drive motor 140, the toolholder 120, or the application tool 190 arranged in the toolholder 120, is biased against a workpiece to be machined, causing the toolholder 120 to slide in the direction 198 towards the drive motor 140. Here, the distance 280 is formed between the actuating element 230 or actuating portion 262 and the motor off-switch 200, and the drive motor 140 is activated.

Furthermore, FIG. 2 illustrates an arrangement of a bearing element 264 between the housing portion 274 and an outer circumference 271 of the toolholder 120. Also shown is the arrangement of the actuating element 230 on the outer circumference 271 of the toolholder 120, as well as axial fixation of the actuating element 230 by a securing element 261 arranged in a positioning groove 272.

The toolholder 120 preferably has an internal receptacle 263 on its side facing the drive motor 140 for accommodating the spring element 180. Moreover, the transmission 145 preferably comprises an output element 265, wherein the output element 265 engages with the internal receptacle 263 of the toolholder 120. Furthermore, the toolholder 120 is preferably axially slidable with respect to the output element 265. It is noted that the drive unit 142 is preferably arranged so as to be axially fixed in the elongated housing 110, and only the toolholder 120 is axially displaceable. As a result, a mechanical coupling can be used.

Preferably, the output element 265 comprises an inner receptacle 266 for partially accommodating the spring element 180. The spring element 180 is arranged between the output element 265, in particular the inner receptacle 266, and the toolholder 120, in particular the inner receptacle 263. Preferably, the inner receptacle 266 of the output element 265 comprises a central positioning pin 267 configured so as to center the spring element 180 in the inner receptacle 263. Preferably, a single spring element 180 is provided. However, a plurality of spring elements 180 arranged in series can also be arranged in the inner receptacle 263 of the toolholder 120. Preferably, a spindle lock 273 is associated with the output element 265. Such a spindle lock 273 is sufficiently known from the prior art, and a detailed description is thus omitted here.

In the illustration, the activation unit 189 is arranged between the application tool 190 and the toolholder 120. The activation unit 189 comprises a printed circuit board 240, on which the motor off-switch 200 is arranged. Furthermore, the activation unit 189 is associated with the actuating element 230 for actuating the motor switch 185 and the motor off-switch 200, respectively. The actuating element 230 is preferably arranged on the outer circumference 271 of the toolholder 120. The printed circuit board 240 is preferably affixed to the elongated housing 110 and is preferably arranged in the region of the front face 103 of the elongated housing 110. In particular, the printed circuit board 240 is preferably connected to a control apparatus for controlling the drive motor 140, wherein the control apparatus is not shown. The control apparatus is preferably positioned so as to be spaced apart from the printed circuit board 240. In particular, the control apparatus is preferably arranged in the region of a side of the drive motor 140 facing the second axial end 102 of the elongated housing 110.

Preferably, the printed circuit board 240 is arranged via a retaining element 268 in the elongated housing 110, particularly in the torque adjustment sleeve 130. In this case, the retaining element 268 preferably comprises a disk-shaped base body with a recess 269. The recess 269 is configured so as to allow the motor off-switch 200 to be arranged therein.

Preferably, two LEDs 251, 252 are associated with the printed circuit board 240. Preferably, the LEDs 251, 252 are provided for creating the work field lighting 160. For this purpose, the LEDs 251, 252 are arranged on one side of the printed circuit board 240 facing the front face 103 of the elongated housing 110, by way of example. According to one embodiment, the control apparatus and the control electronics (410 in FIG. 4) are integrally configured so as to control the work field lighting 160. However, the control apparatus and the control electronics (410 in FIG. 4) can also be configured as separate parts.

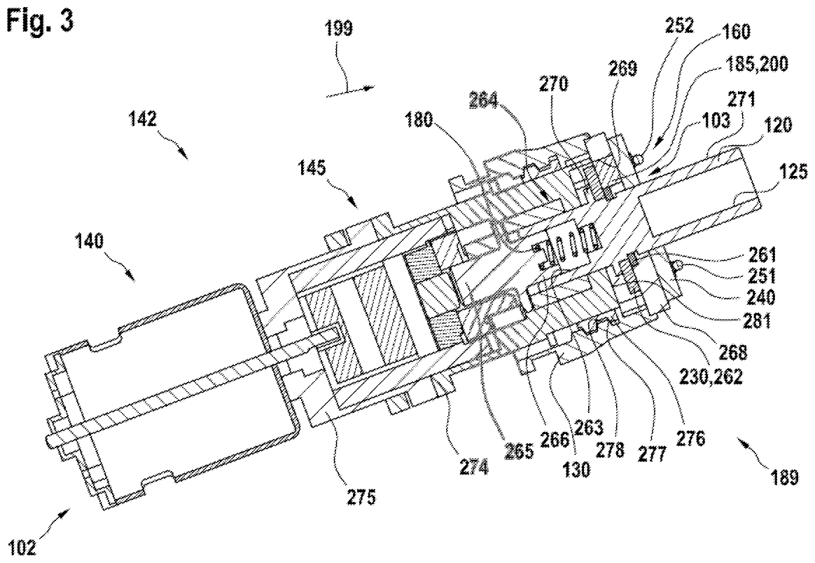

FIG. 3 shows the drive unit 142 of FIG. 1 and FIG. 2 with the activation unit 189. In FIG. 3, the drive motor 140 is deactivated, for example. The actuating element 230 or actuating portion 262 is preferably arranged on the motor off-switch 200, because the toolholder 120 is not biased and the spring element 180 is not compressed. The toolholder 120 or the support element 270 is thereby spaced apart from the front face 281 of the housing part 274.

To deactivate the drive motor 140, the toolholder 120, or the application tool 190 of FIG. 1 arranged in the toolholder 120, is spaced apart from a workpiece to be machined, wherein the toolholder 120 slides into its resting position in the direction 199 facing the drive motor 140. Here, the actuating element 230 or the actuating portion 262 is preferably moved towards the motor off-switch 200, thereby making the distance 280 of FIG. 2 zero and deactivating the drive motor 140. It is noted that the motor off-switch 200 is preferably actuated by the actuating portion 262 upon abutment thereof.

FIG. 4 shows control electronics 410 associated with the hand-held power tool 100 of FIG. 1 for controlling work field lighting 160 of the hand-held power tool 100 of FIG. 1 during a charging operation. Preferably, the control electronics 410 are formed on a printed circuit board. As described above, the control electronics 410 are associated with the work field lighting and are configured so as to visualize a charging of the battery 150 of FIG. 1 by a repeated illumination and dimming of the work field lighting 160 during the charging operation. For this purpose, the control electronics 410 are associated with at least one controller 420, in particular a microcontroller 420.

When the charging apparatus 155 is connected to the hand-held power tool 100 via the charging cable 156, this is detected by the control electronics 410, and the LEDs 251, 252 of FIG. 2 and FIG. 3 of the work field lighting 160 of FIG. 1 to FIG. 3 are controlled via a charging circuit 430 by the microcontroller 420 in such a way that they each alternately illuminate and then dim. A corresponding function of repetitive illumination and dimming is also referred to as “breathing.” It is noted that only the LED 251 is shown by way of example for the LEDs 251, 252 in FIG. 4.

According to one embodiment, the control electronics 410 are configured so as to deactivate the work field lighting 160 after the battery 150 has been fully charged. To detect a fully charged battery 150, the control electronics 410 are associated with a battery charge level sensing unit 440. The battery charge level sensing unit 440 is configured so as to sense a respective current battery charge level. Here, the battery charge level sensing unit 440 can associate different battery states with the battery 150, e.g., “battery empty” or “battery fully charged.” Preferably, the different battery charging states can be visualized for a user in different ways by the work field lighting 160, e.g., by different illumination and dimming in different speeds and/or in different colors.

If a low battery charge is detected, the microcontroller 420 transmits an activation signal to the charging circuit 430 for charging the battery 150. If a fully charged battery 150 is detected, the microcontroller 420 transmits a deactivation signal to the charging circuit 430 in order to stop the charging operation of the battery 150. Preferably, the work field lighting 160 is also deactivated.

As described in FIG. 1, the control electronics 410 is associated with an optional switch element 450, wherein, upon activation of the switch element 450, a charging operation is activatable. Preferably, the switch element 450 is configured in the manner of a switch that is activatable by a user of the hand-held power tool 100. Here, the switch element 450 can be, for example, a tactile switch, a detector switch, and/or a microswitch.

If the charging apparatus 155 is connected to the hand-held power tool 100 via the charging cable 156 and the switch element 450 is activated, the work field lighting 160 will repeatedly illuminate and dim at a low battery charge level. When the battery 150 is fully charged, the work field lighting 160 is deactivated.

When the switch element 450 is activated, but the charging apparatus 155 and empty battery 150 are not connected, the LEDs 251, 252 of work field lighting 160 will flash, illuminate for a predetermined amount of time, and then go off. Any other desired flashing and lighting sequence can also be carried out in this case. If the battery 150 is fully charged when the switch element 450 is activated and the charging apparatus 155 is unconnected, then the LEDs 251, 252 of the work field lighting 160 will illuminate for a predetermined amount of time and then go off. Preferably, the predetermined durations are of varying length. According to a further embodiment, the predetermined time durations can also be the same.

According to a further embodiment, the switch element 450 of the control electronics 410 is configured so as to visualize a battery charge level in the operation of the hand-held power tool 100 upon activation of the switch element 450. Thus, a user of the hand-held power tool 100, in the operation of the hand-held power tool 100, can actuate the switch element 450, and the current battery charge level is visualized via the work field lighting 160. This can be, as described above, e.g., through a fast or slow flashing, illuminating, and dimming and/or illumination in a color associated with the battery charge level.

Alternatively, or optionally, the control electronics 410 are associated with a brightness control 460 for controlling a respective brightness of the work field lighting 160. The brightness control 460 comprises at least one transistor and/or a MOSFET. The brightness control 460 controls a brightness of the work field lighting 160 as a function of an associated power. Here, the control electronics 410 can automatically control the brightness as a function of an ambient brightness, and/or a user of the hand-held power tool 100 can input a desired brightness via an associated control.

FIG. 5 shows a block diagram 540 associated with the control electronics 410 of FIG. 4 with the battery charge level sensing unit 440, the charging circuit 430, the microcontroller 420, the switch element 450, and the brightness control 460. Preferably, the control electronics 410 comprise a detection unit 530 for detecting an external charging apparatus 155 electrically conductively connected to the battery 150. The detection unit 530 is preferably configured so as to initiate or start a charging operation of the battery 150 in response to a detection of the external charging apparatus 155, or a connection of the charging apparatus 155 to the hand-held power tool 100. In particular, with the charging apparatus 155 connected, the detection unit 530 preferably transmits a charging detection signal 505 to the microcontroller 420.

Furthermore, the control electronics 410 preferably comprise a charging control unit 520 configured so as to initiate the charging operation and terminate it after successful charging. For this purpose, a charging control signal 504 is transmitted between the charging control unit 520 and the microcontroller 420.

Also preferably, a battery charge level signal 503 is transmitted from the battery charge level sensing unit 440 to the microcontroller 420. Moreover, preferably, the switch element 450 transmits an activation signal 502 to the microcontroller 420.

As a function of the signals provided to the microcontroller 420, the microcontroller 420 transmits a pulse width modulation (PWM) signal 501 to the brightness control 460, which in turn drives the LEDs 251, 252 of the work field lighting 160. If there is no brightness control 460, the microcontroller 420 preferably transmits the PWM signal 501 directly to the LEDs 251, 252 of the work field lighting 160.

In an exemplary method of charging the battery 150, an electrically conductive connection of the external charging apparatus 155 to the battery 150 or the hand-held power tool 100 takes place in a first step. Subsequently, a detection of the electrically conductive connection of the battery 150 to the charging apparatus 155 is performed by the detection unit 530. Thereafter, the charging operation is activated by the charging control unit 520. Finally, there is an activation of the work field lighting 160, wherein a repeated illumination and dimming of the work field lighting 160 occurs during the charging operation. Preferably, prior to an activation of the charging control unit 520, a detection of a battery charge level is performed by a battery charge level sensing unit 440.

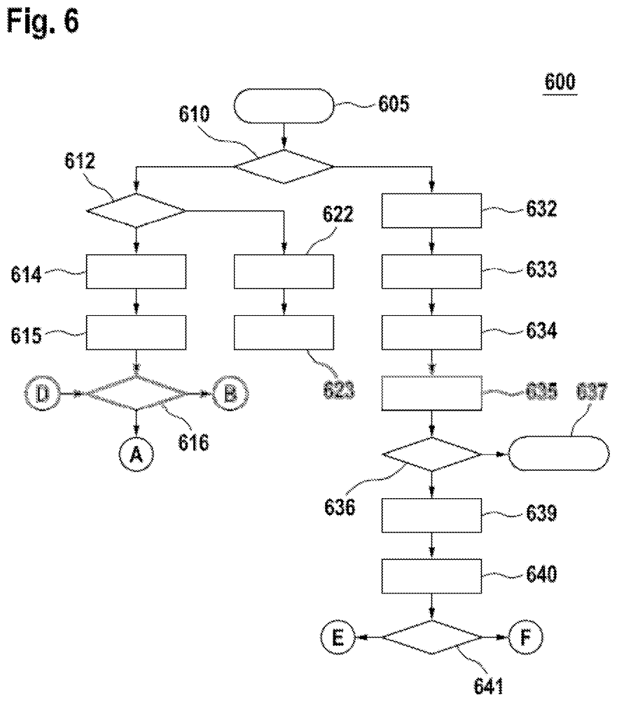

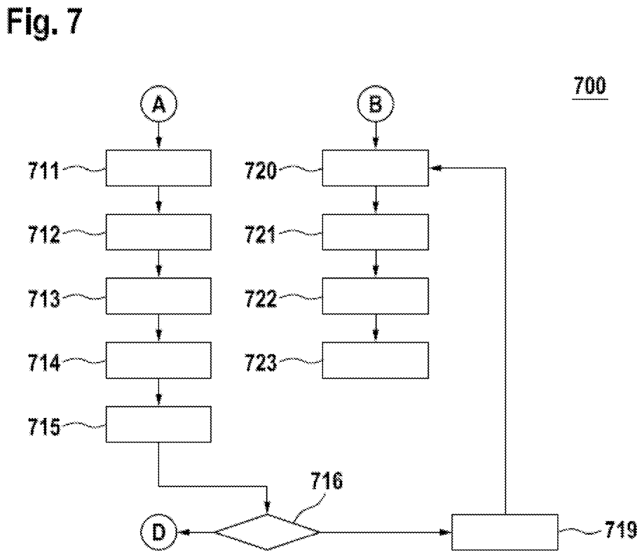

FIG. 6 shows a flow chart 600 that is executed, for example, by the control electronics 410 of FIG. 4 and FIG. 5 and begins at 605. In a first step 610, a query is made as to whether the charging apparatus 155 is connected to the hand-held power tool 100. If a connection is made and an error occurs, then another query 612 occurs. If no error occurs, then the detection unit 530 carries out a detection in step 614, which identifies that the charging apparatus 155 is connected. The charging circuit 430 then transmits a charging detection signal 505 to the microcontroller 420. Then, at step 615, the battery charge level sensing unit 440 detects a current battery charge level and transmits a battery charge level signal 503 to the microcontroller 420. Now, in step 616, a query is made as to whether the battery charge level is low. If the battery charge level is not low, the charging operation continues at B, as described in FIG. 7. If the battery charging level is low, the charging operation continues at A, as described in FIG. 7.

If an error is detected in query 612, then, in step 622, the transmission of the PWM signal 501 is stopped by a software associated with the microcontroller 420. Finally, in step 623, the LEDs 251, 252 are turned off.

If, in step 610, it is detected that the charging apparatus 155 is not connected to the hand-held power tool 100, then, in step 632, a charging control signal 504 of the microcontroller 420 is transmitted to the charging control unit 520, such that a charging operation is ended by the charging control unit 520. Then, in step 633, a charging of the battery 150 is prevented, and, in step 634, the software of the microcontroller 420 stops the transmission of the PWM signal 501. Subsequently, in step 635, the LEDs 251, 252 are turned off. Thereafter, in step 636, a query is made as to whether the switch element 450 is activated. If the switch element 450 is not activated, the charging operation is ended in step 637.

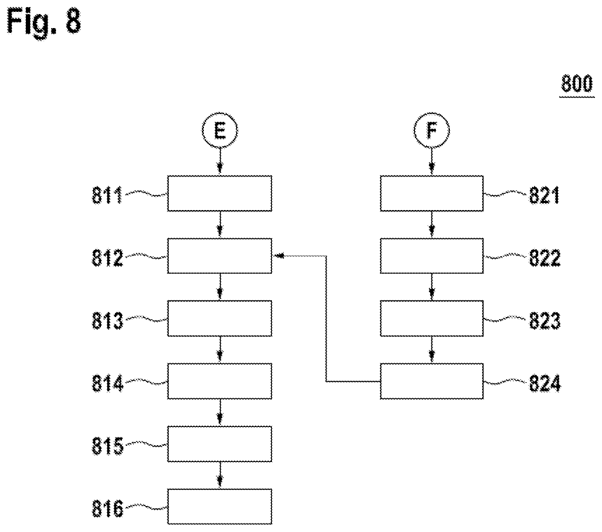

If the switch element 450 is activated, an activation signal 502 is transmitted to the microcontroller 420 in step 639. Subsequently, at step 640, the battery charge level sensing unit 440 detects a current battery charge level and transmits a battery charge level signal 503 to the microcontroller 420. Finally, in step 641, a query is made as to whether the battery charge level is low. If the battery charge level is low, a shutdown will occur at F, as described in FIG. 8. If the battery charge level is not low, the charging operation continues at E, as described in FIG. 8.

FIG. 7 shows a flow chart 700 that is executed, for example, by the control electronics 410 of FIG. 4 and FIG. 5. At A, i.e., as a function of a result of the query 616 of FIG. 6, at a low battery charge level, step 711 continues. In this step 711, the microcontroller 420 transmits a charging control signal 504 to the charging control unit 520 to start the charging control unit 520. Then, in step 712, the battery 150 is charged. The software of the microcontroller 420 generates the PWM signal 501 in step 713. Preferably, the PWM signal 501 is a slowly alternating signal of a predetermined frequency. In step 714, the PWM signal 501 is transmitted to the LEDs 251, 252 so that the LEDs 251, 252 subsequently repeatedly illuminate and dim in step 715. Finally, in step 716, a query is made as to whether the external charging apparatus 155 is separate. If not, the charging operation returns to D, as shown in FIG. 6, and again runs query 616 of FIG. 6.

If the external charging apparatus 155 is separate from the hand-held power tool 100, the detection unit 530 identifying that the charging apparatus 155 is not connected is detected in step 719. The charging circuit 430 then transmits a charging detection signal 505 to the microcontroller 420. Now, in step 720, which occurs at B after step 616 of FIG. 6, a charging control signal 504 of the microcontroller 420 is transmitted to the charging circuit 430, and the function of the charging control unit 520 is terminated. Then, in step 721, a charging of the battery 150 is prevented or blocked. At step 722, the software of the microcontroller 420 stops the generation of the PWM signal 501. Then, in step 723, the LEDs 251, 252 are turned off.

FIG. 8 shows a flow chart 800 that is executed, for example, by the control electronics 410 of FIG. 6 and FIG. 7. At E, starting from step 641 of FIG. 6, step 811 is started at which the hand-held power tool 100 is started. In the next step 812, the software of the microcontroller 420 generates a constant PWM signal for a predetermined amount of time. In the next step 813, the microcontroller 420 transmits the PWM signal to the LEDs 251, 252, such that the LEDs 251, 252 are permanently switched on in step 814. Then, the software of the microcontroller 420 stops the generation of the PWM signal, and finally, in step 816, the LEDs 251, 252 go out.

Similarly, at F, after query 641 of FIG. 6, when the battery charge level is low, a starting of the hand-held power tool 100 also occurs in step 821. Then, in step 822, the software of the microcontroller 420 generates an alternating PWM signal for a predetermined amount of time. In the next step 823, the microcontroller 420 transmits the PWM signal to the LEDs 251, 252 such that the LEDs 251, 252 flash in step 824. Steps 812 to 816 are then performed in order to switch off the LEDs 251, 252.

What is claimed is:

1. A hand-held power tool, in particular a screwdriver, having a work field lighting and an elongated housing, in which a drive unit is arranged, comprising:
at least one drive motor configured to drive a toolholder, wherein the toolholder is configured so as to accommodate an application tool; and
a battery configured to provide a network-independent power supply, wherein
the battery is configured to be electrically conductively connected to an external charging apparatus to charge the battery in a charging operation, and
a control electronics is associated with the work field lighting and is configured to visualize the charging of the battery in the charging operation by a repeated illumination and dimming of the work field lighting.

2. The hand-held power tool according to claim 1, wherein the control electronics comprise a detection unit configured to detect the external charging apparatus when electrically conductively connected to the battery, and is configured to initiate the charging operation of the battery in response to the detection of the external charging apparatus.

3. The hand-held power tool according to claim 2, wherein the control electronics further comprise a charging control unit configured to initiate the charging operation and to terminate the charging operation after a successful charging.

4. The hand-held power tool according to claim 1, wherein the control electronics are further associated with a battery charge level sensing unit which is configured to sense a current battery charge level.

5. The hand-held power tool according to claim 1, wherein:
the control electronics are further associated with a brightness control configured to control a brightness of the work field lighting; and
the brightness control comprises at least one transistor and/or one MOSFET.

6. The hand-held power tool according to claim 1, wherein the control electronics are further configured to deactivate the work field lighting when the battery has been fully charged by the charging operation.

7. The hand-held power tool according to claim 1, wherein:
the control electronics are further associated with a switch element; and
upon an activation of the switch element a battery charge level is visualizable in the operation of the hand-held power tool.

8. The hand-held power tool according to claim 7, wherein the switch element is configured as a switch activatable by a user of the hand-held power tool.

9. The hand-held power tool according to claim 1, wherein:
the hand-held power tool further comprises an activation unit configured to activate the drive motor;
the activation unit is configured to activate the drive motor upon a biasing of an application tool arranged in the toolholder, against a workpiece to be machined; and
the biasing is along a longitudinal axis of the hand-held power tool.

10. A method of charging a battery of a hand-held power tool, in particular a screwdriver, comprising a work field lighting and an elongated housing, in which a drive unit having at least one drive motor configured to drive a toolholder is arranged, and in which a battery configured to supply network-independent power is arranged, wherein, in a charging operation for a charging, the battery is electrically conductively connectable to an external charging apparatus, comprising:
electrically conductively connecting the charging apparatus to the battery;
detecting, with a detection unit, the electrically conductive connection of the battery to the charging apparatus;
activating a charging operation using a charging control unit; and
activating the work field lighting, wherein a repeated illumination and dimming of the work field lighting occurs during the charging operation.

11. The method according to claim 10, further comprising, prior to an activation of the charging control unit:
detecting a battery charge level using a battery charge level sensing unit.
